(19) United States
(12) Patent Application Publication
(10) Pub. No.: US 2008/0084399 A1
(43) Pub. Date: Apr. 10, 2008

(54) Method And Apparatus For Touch Scrolling

(75) Inventors: Johnson Chua, Singapore (SG); Teck Chee Lee, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd., Singapore (SG)

(21) Appl. No.: 11/632,991

(22) PCT Filed: Jul. 1, 2005
(86) PCT No.: PCT/SG05/00216

§ 371 Date: Jan. 19, 2007

(30) Foreign Application Priority Data
Jul. 19, 2004 (SG) 200405539-8
Sep. 10, 2004 (SG) 200405571-1

(51) Int. Cl. G06F 3/041

(52) U.S. Cl. 345/173

(57) ABSTRACT

Apparatus for touch scrolling, the apparatus comprising a scrolling activator for scrolling activation by a finger of a user, the scrolling activator comprising a first end zone adjacent a first end of the scrolling activator for fast scrolling in a first scrolling direction, a second end zone adjacent a second end of the scrolling activator for fast scrolling in a second scrolling direction, and a normal zone for normal scrolling.

### FIELD OF THE INVENTION

This invention relates to a method and apparatus for touch scrolling and refers particularly, though not exclusively, to such a method and apparatus for use in a portable device.

### BACKGROUND OF THE INVENTION

Portable devices such as, for example, mobile/cellular telephones, personal digital assistants, media players, audio players, MP3 players, multi-media players, video players, DVD players, CD players and VCD players, often have a scrolling function for a track and/or menu control and selection. The scrolling function is normally activated by us of one of: two buttons, one for scroll up and one for scroll down; a circular scroller by either mechanical or captive operation; a top-mounted hand-roller; a side-mounted roller; or a side-mounted circular roller.

These all provide the basic requirements to a user for the scroll functions, and may include a select/enter function. Some are counter-intuitive as the user needs to move the scrolling activator clockwise or anti-clockwise for up or down rather than an up movement for scrolling up, and or down movement for scrolling down. An example of such an activator is the circular scroller.

A naturally intuitive scrolling activator would be of advantage.

### SUMMARY OF THE INVENTION

In accordance with a first preferred aspect there is provided apparatus for touch scrolling. The apparatus comprises a scrolling activator for scrolling activation by a finger of a user. The scrolling activator comprises a first end zone adjacent a first end of the scrolling activator for fast scrolling in a first scrolling direction, a second end zone adjacent a second end of the scrolling activator for fast scrolling in a second scrolling direction, and a normal zone for normal scrolling.

According to a second aspect there is provided a portable device comprising a casing having at least one wall; a display for displaying a plurality of items for selection; and a scrolling activator for scrolling the plurality of items and being for selection of at least one of the plurality of items. The scrolling activator comprises a first end zone adjacent a first end of the scrolling activator for fast scrolling in a first direction, a second end zone adjacent a second end of the scrolling activator for scrolling in a second direction, and a normal zone for normal scrolling.

The normal zone may be between the first zone and the second zone. The scrolling activator may be elongate and may be for linear scrolling activation.

According to a third aspect there is provided a portable device comprising a casing having at least one wall, a display for displaying a plurality of items for selection; and a scrolling activator for scrolling the plurality of items and selection of at least one of the plurality of items. The scrolling activator comprises a normal zone for normal scrolling, the scrolling activator being elongate and being for linear scrolling activation.

There may be a perimeter side wall extending around a periphery of the scrolling activator for providing a defined boundary able to be felt by the finger. The scrolling activator may comprise a portion of reduced thickness in a wall of the apparatus. Alternatively, the wall may be of uniform thickness and has re-enforcing except at the scrolling activator.

There may be sensors mounted beneath the scrolling activator, and an enter button mounted within the scrolling activator.

The apparatus may be a portion of a portable device. The portable device may be at least one of: mobile telephone, cellular telephone, personal digital assistant, media player, multi-media player, audio player, MP3 player, video player, DVD player, CD player and VCD player.

The normal zone may include at least one of: motion accelerated scrolling, a press and hold function, and a tap function. The press and hold function may be activated after a predetermined minimum time of at least 0.5 seconds. Activation of the fast scrolling in the first and second directions may be after a predetermined time delay. The time delay may be in the range 0.1 to 1.5 seconds, preferably 0.3 to 0.8 seconds.

According to a fourth aspect there is provided a method for activating scrolling a plurality of items displayed on a display. The method comprises determining if a finger of a user has contacted a scrolling activator in at least one of three zones. If the finger is in a fast up scroll zone of the three zones, fast up scroll is activated after a first predetermined time delay during which the finger remains in contact with the fast up scroll zone. If the finger is in a fast down scroll zone of the three zones a fast down scroll is activated after a second predetermined time delay during which the finger remains in contact with the fast down control zone. If the finger is in a normal zone of the three zones, a direction of movement of the finger is determined and scrolling takes place in that direction.

A speed of movement of the finger may also be determined, and scrolling may be a scrolling speed proportional to the finger speed. The scrolling activator may be elongate and finger movement in the normal zone may be linear. The first time delay and the second time delay may be the same. The first and second time delays may be in the range 0.1 to 1.5 seconds, preferably 0.3 to 0.8 seconds.

### BRIEF DESCRIPTION OF THE DRAWINGS

In order that the present invention may be fully understood and readily put into practical effect, there shall now be described by way of non-limitative example only preferred embodiments of the present invention, the description being with reference to the accompanying illustrative drawings in which:

FIG. 1 is a front view of a portable device in accordance with a first embodiment;

FIG. 2 is an enlarged view of a second embodiment of the scroll activator shown in FIG. 1;

FIG. 3(a) is a vertical cross-sectional view along the lines and in the direction of arrows 3-3 of FIG. 2;

FIG. 3(b) is an alternative vertical cross-sectional view along the lines and in the direction of arrows 3-3 of FIG. 2;

FIG. 4(a) is a block diagram of part of the electronic structure of the device of FIGS. 1 to 3;

FIG. 4(b) is a block diagram of part of an alternative electronic structure of the device of FIGS. 1 to 3;

FIG. 5 is a flow chart for a fast scrolling function;

FIG. 6 is a flow chart for a normal scrolling function.

### DETAILED DESCRIPTION OF THE PREFERRED EMBODIMENTS

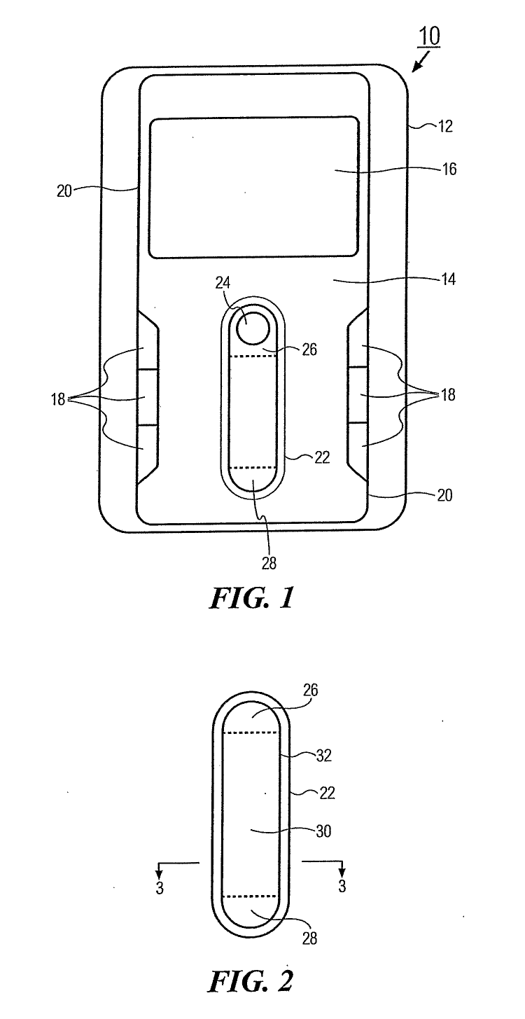

To refer to FIG. 1 there is shown a mobile device 10. The mobile device 10 may be one or more of: mobile telephone, a cellular telephone, a personal digital assistant, media player, audio player, MP3 player, multi-media player, video player, DVD player, CD player, and VCD player. The device 10 therefore contains all the necessary functionality and apparatus for such players. All players may also have a recording function.

The mobile device 10 as illustrated is an audio and MP3 player and has a casing 12 with a main wall 14, a display 16 mounted in the main wall 14, and control buttons 18 each of pre-set functionality also in the main wall 14, but at outer-edges 20 thereof.

Forming part of main wall 14 intermediate the two sets of control buttons 18 is a scrolling activator 22. The scrolling activator 22 is elongate and extends longitudinally of wall 14. It is located below display 16 so that when a user is operating scrolling activator 22 such use should not interrupt a view of display 16.

Although scrolling activator 22 is illustrated as being parallel to the longitudinal axis of device 10, it may be at any angle relative to the longitudinal axis of device 10.

A select or enter button 24 may be located within the boundaries of scrolling activator 22, if required or desired, but may not form part of the scrolling activator 22. The select button 24 may be located at any desired position along and across activator 22 such as, for example, at a top end 32, as illustrated. As shown in FIG. 2, the button 24 may be deleted. The select button 24 may also be located elsewhere in wall 14. The select or enter button 24 is to select a highlighted item in a list of items on display 16.

As shown in FIGS. 1 and 2, the scrolling activator 22 may have a number of zones. The upper zone 26 is at or adjacent the top of the scrolling activator 22. If button 24 is provided at the top of scrolling activator 22, zone 26 is below button 24. Upper zone 26 is a fast “up” scroll area so that contact of a user's finger, other digit or other part of a human body (“finger”) on or within zone 26 will cause a fast “up” scrolling. Similarly, lower zone 28 is at or adjacent the button of the scrolling activator. If button 24 is provided at the bottom of scrolling activator 22, zone 28 is above the button 24. Lower zone 28 is a fast “down” scroll area so that contact of a user's finger on or within zone 28 will cause a fast “down” scrolling. The fast up and down scrolling speeds are pre-set and are the normal maximum, reliable scrolling speed of display 16. They are preferably such that an operator can view the scrolling list on display 16, and the normal maximum scrolling speed provides rapid movement through a list of items while allowing the operator some perception of the present location within the list of the items to permit the operator to stop at or in the vicinity of a desired location. However, the scrolling speeds may be user selected from a number of predetermined fast scrolling speeds.

Between zones 26, 28 is the normal zone 30. Within normal zone 30, contact of a finger with a linear movement of the finger up or down along and relative to the normal zone 30 will activate the scrolling function up or down in accordance with the direction of finger movement. The movement of the finger is generally along the longitudinal axis of scrolling activator 22. Linear motion of the finger is also generally in a straight line and does not include a clearly curved motion, nor accurate or circular.

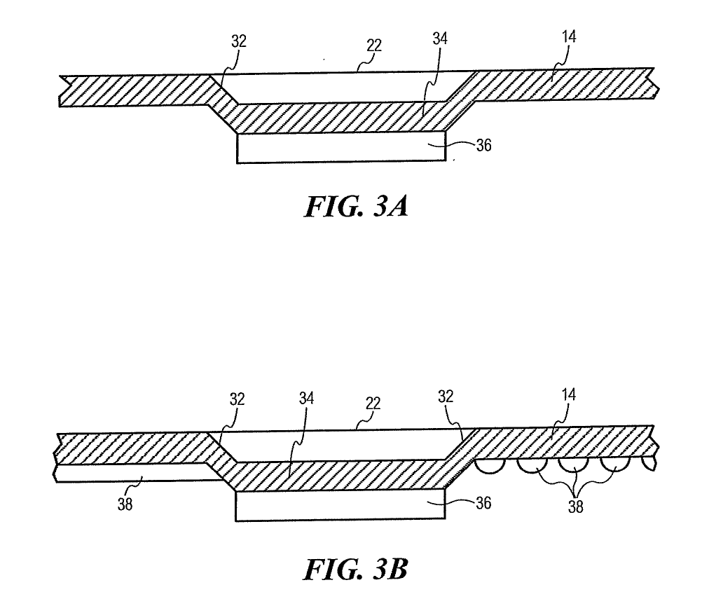

As is shown in FIG. 3(a), the scrolling activator 22 is recessed into main wall 14 to provide perimeter walls 32 around the periphery of scrolling activator 22. Perimeter walls 32 provide a user with a defined boundary to the scrolling activator 22 that can easily be felt with a finger. In this way a user has a clearly defined area in which to operate, the area being able to be determined even in total darkness, or to the visually disabled. The recessed portion 34 is preferably of reduced wall thickness to enable sensors 36 located beneath portion 34 to be able to operate. The sensors 36 may be any appropriate sensors such as, for example, SYNPATICS® SCROLLSTRIP® sensors available from Synpatics Incorporated of San Jose, Calif., USA.

FIG. 3(b) shows an alternative. Here, the wall 14 is of constant thickness even at recessed portion 34 of scrolling activator 22, but for the portions of wall 14 other than at scrolling activator 22, re-enforcing such as by ribs 38 may be provided to give wall 14 the necessary strength. Alternatively, integral re-enforcing may be used.

The end zones 26, 28 may be delineated from normal zone 30 by graphic indicators such as, for example, a line, different colours, or the like; and/or a physical delineation such as, for example, an indentation, raised edge, being physically separate, and so forth.

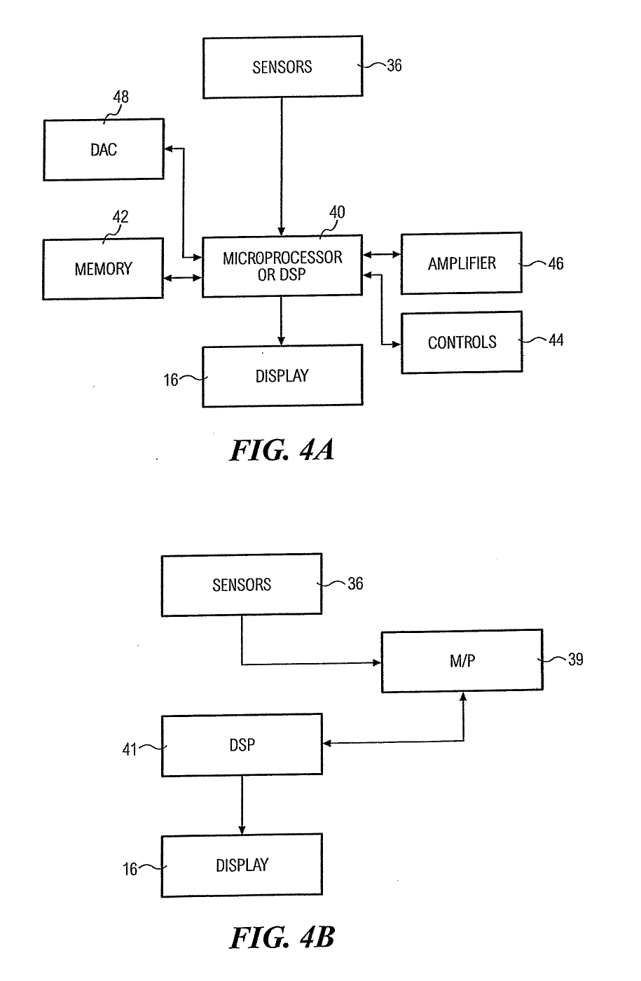

FIG. 4(a) shows a part of the electronic structure of device 10. The sensors 36 output to a microprocessor or digital signal processor 40. Microprocessor or digital signal processor 40 coordinates the operation of the scroll strip on display 16, and display 16. The microprocessor or digital processor 40 also determines the speed of scrolling required in response to the speed of finger movement in normal zone 30. The microprocessor or digital signal processor 40 also controls many other functional elements of device 10 in a known manner such as, for example, memory (e.g. RAM and/or disk drive and/or flash memory) 42, controls 44, CODEC 46, digital-to-analog converter, and so forth.

FIG. 4(b) shows a variation where there is a microprocessor 39 and a digital processor. The DSP 41 controls display 16. Microprocessor 39 may be used to control power management, lighting, and others.

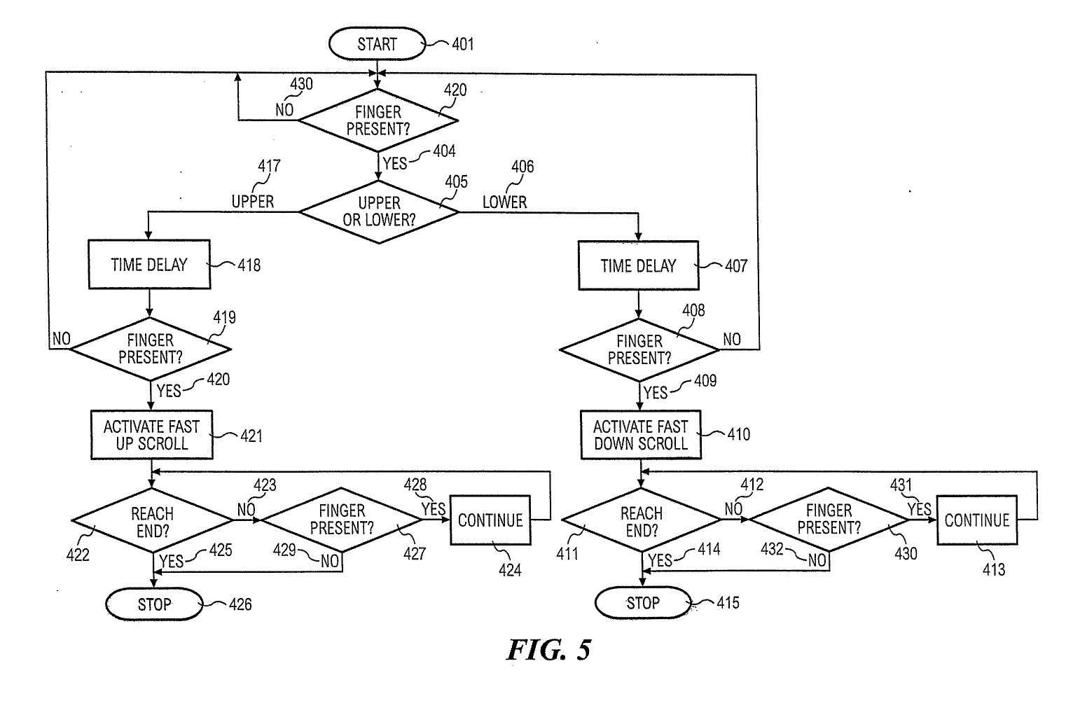

The process flow for the end zones 26, 28 is shown in FIG. 5. Upon the device 10 being switched on (401), the sensors 34 awaits the detection of a finger (402). If a finger is not detected (403) the sensors 34 cycle until a finger is detected (404). The next step is to determine (405) if it is the upper zone 26 or lower zone 28. If lower zone (406), after a time delay (407) a query is raised to determine if the finger is still present (408). If yes (409) the fast down scroll is activated (410). A query is then raised to determine if the end is reached (411) and if not (412), a further query is raised to determine if a finger is still present (430). If yes (431) scrolling continues (413). If not (432) scrolling ceases (415). If the end is reached (414), fast down scrolling stops (415). If at 408 the result is no (416), the process reverts back to before (402).

If at query 405 the result is that the finger is at the upper zone (417), after the same time delay (418) the same query is raised to determine the finger is still present (419). If yes (420) the fast up scroll is activated (421). A query is raised (422), to determine if the end is reached. If not (423), a further query is raised to determine if a finger is still present (427). If yes (428) scrolling continues (424). If not (429) scrolling ceases (426). If the end is reached (425), scrolling stops (426). If at 419 the result is no (427), the process reverts back to before 402.

The time delays (407, 415) may be introduced for the fast scrolling functions (410, 421) so that if a user accidentally and briefly contacts either zone 26, 28, the fast scrolling function (410, 421) will not be accidentally activated. The time 407, 418 delay may be preset, may be user set, or may be user selected from a pre-set list of possible delay times. Preferably, the time delay is in the range of 0.1 to 1.5 seconds, more preferably 0.3 to 0.8 seconds.

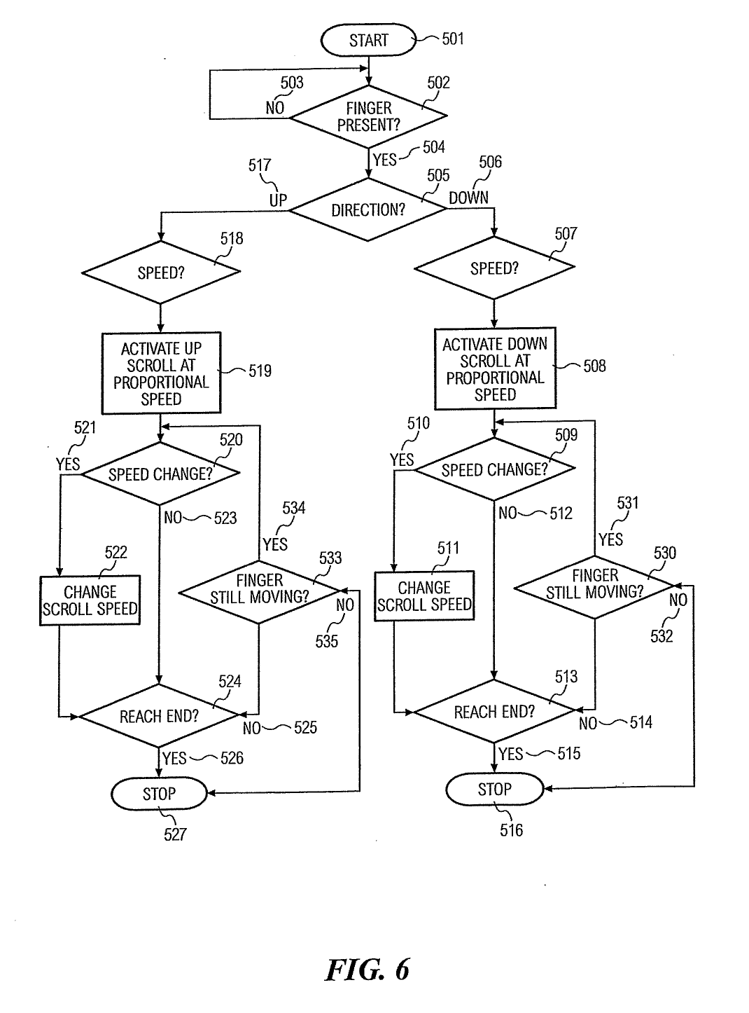

The process flow in the normal zone 30 is shown in FIG. 6. After the device 10 is switched on (501) the sensors 34 await the detection of a finger (502). If a finger is not detected (503) the sensors 34 cycle until a finger is detected at (505). The sensors 34 determine if the motion of the finger is up or down (505). If down (506) the sensors 34 determine the speed of motion (507) and activate (508) the down scroll function at a speed proportional to the speed of movement of the finger.

If there is a speed change (509, 510), the scroll speed will change in proportion to the changed speed (511). If not (512), scrolling continues at the original speed. A query is raised to determine if the end has been reached (513). If not (514) a query is raised to determine if the finger is still moving (530). If yes (531), the process reverts back to before 509. If the finger is no longer moving (532) the process stops. If yes (515) at (513), the scrolling stops (516).

If at 505 it is up (517), the sensors 34 determine the speed of motion (518) and activate (519) the up scroll function at a speed proportional to the speed of movement of the finger.

If there is a speed change (520, 521), the scroll speed will change in proportion to the changed speed (522). If not (523), scrolling continues at the original speed. A query is raised to determine if the end has been reached (524). If not (525) a query is raised to determine if the finger is still moving (533). If it is (534), the process reverts back to before 520. If not (535), the process stop (527). If yes (526) at (524), the scrolling stops (527).

The sampling by sensors 34 may be at a predetermined rate such or, for example, in the range of every 0.5 to 12.5 ms.

Preferably, there is a motion accelerated scrolling so that the faster the finger is moved along the normal zone 30 of scrolling activator 22 the faster will be the scrolling. The maximum scrolling speed achievable with motion accelerated scrolling is that of the fast scrolling zones 26, 28. Motion accelerated scrolling will not apply to the fast scrolling zones 26, 28.

A tap, or double tap, function may also be incorporated within the normal zone 30 but not the fast scrolling zones 26,28 so that upon the normal zone 30 being tapped, or double tapped, it will active the selected menu item or track displayed or display 16. The tap or double tap is therefore treated as an enter or select function.

Furthermore, a press and hold function may be incorporated within the normal zone 30 but not the fast scrolling zones 26,28 so that if a user presses and holds on the normal zone 30, a selected menu function of display 16 will move to a different state of that function. A prescribed minimum time delay for the press and hold may be preset and may be at least 0.5 seconds.

Whilst there has been described in the foregoing description preferred embodiments of the present invention, it will be understood by those skilled in the technology concerned that may variations or modifications in details of design or construction may be made without departing from the present invention as defined in the claims.

1-44. (canceled)

45. A portable device comprising:
(a) a casing having at least one wall;
(b) a display for displaying a plurality of items for selection; and
(c) a scrolling activator for scrolling the plurality of items and selection of at least one of the plurality of items, wherein the scrolling activator comprises a zone for scrolling and activation of scrolling in the zone for scrolling is by linear movement of a finger.

46. A portable device as claimed in claim 45, further comprising a perimeter side wall extending around a periphery of the scrolling activator for providing a defined boundary to the scrolling activator able to be felt by the finger.

47. A portable device as claimed in claim 45, wherein the scrolling activator comprises a portion of reduced thickness in a wall of the apparatus, sensors being mounted beneath the portion of reduced thickness.

48. A portable device as claimed in claim 45, wherein an enter button is mounted within the scrolling activator.

49. A portable device as claimed in claim 45, wherein the portable device is at least one selected from the group consisting of: mobile telephone, cellular telephone, personal digital assistant, media player, multi-media player, audio player, MP3 player, video player, DVD player, CD player and VCD player.

50. A portable device as claimed in claim 45, wherein the portable device supports motion accelerated scrolling.

51. A portable device as claimed in claim 45, wherein the portable device supports both proportional scrolling and motion accelerated scrolling.

52. A portable device as claimed in claim 50, wherein the display and the scrolling activator are spatially separate from each other.

53. A portable device as claimed in claim 51, wherein the display and the scrolling activator are spatially separate from each other.

54. Apparatus for touch scrolling, the apparatus comprising a scrolling activator for scrolling activation by a finger of a user, the scrolling activator comprising:
a first end zone adjacent a first end of the scrolling activator for fast scrolling in a first scrolling direction,
a second end zone adjacent a second end of the scrolling activator for fast scrolling in a second scrolling direction,
and a normal zone for normal scrolling.

55. Apparatus as claimed in claim 54, wherein the scrolling activator is elongate, and in the normal zone, activation of scrolling is by linear movement of a finger.

56. Apparatus as claimed in claim 54, further comprising a perimeter side wall extending around a periphery of the scrolling activator for providing a defined boundary of the scrolling activator able to be felt by the finger.

57. Apparatus as claimed in claim 54, wherein the normal zone is between the first zone and the second zone.

58. Apparatus as claimed in claim 54, wherein fast scrolling in the first and second directions is activated by a finger after a predetermined time delay.

59. Apparatus as claimed in claim 58, wherein the predetermined time delay is in the range 0.1 to 1.5 seconds.

60. Apparatus as claimed in claim 58, wherein the predetermined time delay is in the range 0.3 to 0.8 seconds.

61. Apparatus as claimed in claim 54, wherein the scrolling activator comprises a portion of reduced thickness in a wall of the apparatus, sensors being mounted beneath the portion of reduced thickness.

62. Apparatus as claimed in claim 54, wherein the scrolling activator is part of a wall of the apparatus, the wall being of uniform thickness, and having re-enforcing except at the scrolling activator.

63. Apparatus as claimed in claim 54, wherein the apparatus is a portion of a portable device, the portable device being at least one selected from the group consisting of: mobile telephone, cellular telephone, personal digital assistant, media player, multi-media player, audio player, MP3 player, video player, DVD player, CD player and VCD player.

64. Apparatus as claimed in claim 54, wherein the normal zone supports at least one of: motion accelerated scrolling, a press and hold function, and a tap function.
